(19) United States
(12) Patent Application Publication
(10) Pub. No.: US 2022/0195218 A1
(43) Pub. Date: Jun. 23, 2022

(54) HIGH-REFRACTIVE INDEX MICROSPHERE MIE SCATTERING-BASED SCHEMOCHROME COATING

(71) Applicant: DALIAN UNIVERSITY OF TECHNOLOGY, Dalian, Liaoning (CN)

(72) Inventors: Suli WU, Dalian, Liaoning (CN); Yue WU, Dalian, Liaoning (CN); Jie CHANG, Dalian, Liaoning (CN)

(21) Appl. No.: 17/594,718

(22) PCT Filed: Apr. 28, 2020
(86) PCT No.: PCT/CN2020/087390

§ 371 Date: Nov. 1, 2021

(30) Foreign Application Priority Data
Apr. 30, 2019 (CN) 201910363788.5

(51) Int. Cl. C09D 7/40; C09D 7/61; C09D 7/63; C09D 7/45; C09D 129/04; C09D 1/06; C09D 133/08

(52) U.S. Cl. CPC C09D 7/70; C09D 7/68; C09D 7/61; C09D 7/63; C08K 7/18; C09D 129/04; C09D 1/06; C09D 133/08; C09D 7/45

(57) ABSTRACT

A structural color coating based on Mie scattering of high-refractive index microspheres has the following components in parts by mass: 5 to 20 parts of nano microspheres having a highly uniform particle size and a theoretical refractive index greater than 1.7, 75 to 90 parts of dispersion liquid, 0.1 to 5 parts of a surfactant, and 1 to 5 parts of an adhesive. The structural color coating forms a local microcosmic ordered, macroscopic long-range disordered structural film by means of spraying coating, blade coating, brushing coating, roll coating or dip-coating; the matrix is glass, metal, textile, ceramic, plastic or paper; the surfactant is sodium dodecyl benzene sulfonate, cetyl sodium sulfate, stearic acid, or sodium stearate; the nano microsphere is at least one of ZnS, ZnO, CdS, Cu₂O, CaS, CuS, Cu₂S, TiO₂, ZrO₂ or CeO₂; the particle size of the nano microspheres ranges from 200 to 500 nm.

### TECHNICAL FIELD

The present disclosure relates to a structural color coating based on Mie scattering of high-refractive index microsphere, belonging to the field of structural color.

### BACKGROUND

In nature, there are two sources of color: pigmentary color and structural color. Compared with pigmentary color, structural color has the advantages of high brightness, high saturation and never fading. Structural color results from the interaction of visible light with the micro-nano structure of matter, such as scattering, interference or diffraction. At present, the study of artificial build structural color is mainly realized by photonic crystal and amorphous photonic structures. Photonic crystal structure is the most common way to achieve structural color build, which can generate brilliant structural color (see patent CN200710064245.0; X. Wang, Z. Wang, L. Bai, H. Wang, L. Kang, D. H. Werner, M. Xu, B. Li, J. Li and X.-F. Yu, Opt. Express, 2018, 26, 27001-27013). However, the used colloidal microspheres are usually polymer microspheres and SiO2 microspheres. According to Bragg equation, the angle dependence of the structural color film built by these colloidal microspheres with a low-refractive index is strong, which is not conducive to human visual perception. The angle independent structural color can be realized by amorphous photonic structure with a characteristic size of visible light wavelength order, and the microstructure units are arranged in short-range order and long-range disorder (see W. Yuan, N. Zhou, L. Shi and K.-Q. Zhang, ACS Applied Materials & Interfaces, 2015, 7, 14064-14071; Q. Li, Y Zhang, L. Shi, H. Qiu, S. Zhang, N. Qi, J. Hu, W. Yuan, X. Zhang and K.-Q. Zhang, ACS Nano, 2018, 12, 3095-3102). Due to the disorder of the structure, the scattered light will be scattered in all directions in the whole space, and the short-range order will make the scattered light coherent superposition, thereby the angle independent structural color will be built. The angle independent structural color is more suitable for human visual perception, but this kind of structural color film usually has the disadvantage of dull color.

Mie scattering refers to the scattered light in any direction of space emitted by isotropic uniform spherical particles by scattering incident light, wherein the isotropic uniform spherical particles having a diameter equivalent to the radiation wavelength. High-refractive index microspheres, having a particle size greater than 200 nm and a theoretical refractive index greater than 1.7, will theoretically generate Mie scattering to visible light. However, the Mie scattering of a single microsphere is weak, and no macroscopic color can be observed. When the coating of the present disclosure builds a locally ordered assembled structure on the matrix, the coherent superposition of the Mie scattering of uniform microspheres greatly enhances the intensity of Mie scattering, thereby bright structural color can be generated. At the same time, because the film built by the coating of the present disclosure on the matrix is a macroscopic disordered structure, its Mie scattering is scattered in all directions of space, the generated structural color can be seen from all angles and has angle independence. Therefore, it is of great significance for production and life to build short-range ordered and long-range disordered structures based on Mie scattering of high-refractive index microspheres to generate full-angle visible structural colors under natural light.

### SUMMARY OF THE INVENTION

The present disclosure provides a structural color coating based on Mie scattering of high-refractive index microsphere.

A structural color coating based on Mie scattering of high-refractive index microsphere, includes components in parts by mass as follows: 1 to 20 parts of nano microspheres with a highly uniform particle size and a theoretical refractive index greater than 1.7, 75 to 90 parts of dispersion liquid, 0.1 to 5 parts of surfactant and 1 to 5 parts of adhesive.

The color of the structural color coating is derived from the coupling of the Mie scattering of light to the single-layer or multi-layer structure assembled on the matrix by the high-refractive index microspheres with a highly uniform particle size and a refractive index greater than 1.7 in the coating components, wherein the structure is local microcosmic ordered and macroscopic long-range disordered structure. The color generated is brilliant and belongs to a kind of structural color, which has nothing to do with the color of the high-refractive index microspheres itself in the coating.

By changing the particle sizes of the high-refractive index microspheres in the structural color coating, brilliant structural colors such as purple, blue, green, yellow, red and the like, which includes the full spectral range and are angle independent, can be obtained.

Further, the nano microsphere, having a highly uniform particle size and a theoretical refractive index greater than 1.7, is preferably at least one of ZnS, ZnO, CdS, Cu₂O, CaS, CuS, Cu₂S, TiO₂, ZrO₂, and CeO₂.

Further, the high-refractive index nano microsphere has a particle size ranging from 150 to 600 nm, and preferably ranging from 200 to 500 nm.

Further, the dispersion liquid is a hydrophilic solution having a low boiling point, and preferably the dispersion liquid is at least one of acetone, water and ethanol.

Further, the adhesive is at least one of polyvinyl alcohol, polymethyl acrylate, polyethyl acrylate, polybutyl acrylate, polymethyl methacrylate, polyethyl methacrylate, polybutyl methacrylate, and sodium silicate.

Further, the surfactant is one of sodium dodecyl benzene sulfonate, cetyl sodium sulfate, stearic acid, and sodium stearate.

Further, the coating is suitable for a variety of substrates, and the substrate is one of silicon wafer, glass, metal, textile, ceramic, and plastic.

Further, the structural color coating is suitable for generating the structural color by spaying coating, blade coating, brushing coating, roll coating, or dip-coating.

### Beneficial Effects of the Invention

The present disclosure discloses a structural color coating based on Mie scattering of high-refractive index microsphere. The color of structural color coating is derived from the single-layer or multi-layer structure assembled on the matrix by the high-refractive index microspheres with a uniform particle size in the coating, and the structure is a local microcosmic ordered and macroscopic long-range disordered structure. This color belongs to a kind of structural color. Compared with the structures and generated colors of the other structural color, the color of the present disclosure can be seen under natural light, no special light source illumination or specular reflection viewing angle is required, and the structural color generated is more brilliant. In addition, a variety of angle independent structural colors such as purple, blue, green, yellow, red and the like can be obtained by changing the particle sizes of the high-refractive index microspheres added in the coating.

### DETAILED DESCRIPTION OF DRAWINGS

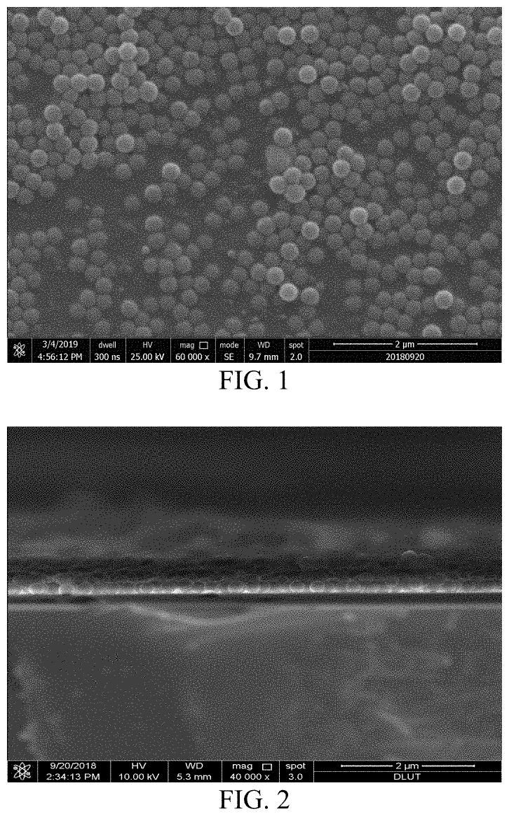

FIG. 1 is a plane scanning electron microscopy image of the green structural color film obtained in Embodiment 1.

FIG. 2 is a cross-sectional scanning electron microscope image of the green structural color film obtained in Embodiment 1.

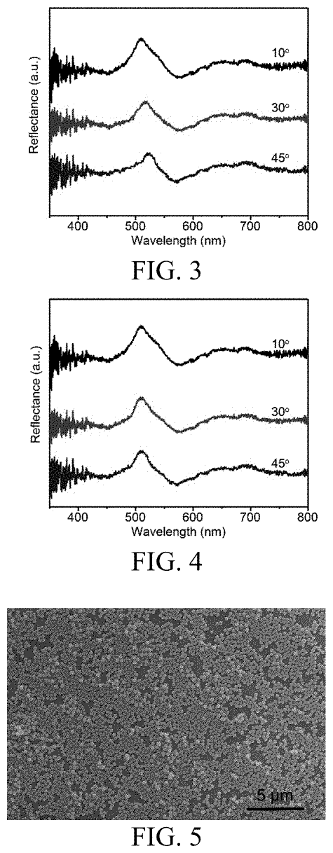

FIG. 3 is a reflection spectrum of the green structural color film obtained in Embodiment 1.

FIG. 4 is a scattering spectrum of the green structural color film obtained in Embodiment 1.

FIG. 5 is a plane scanning electron microscopy image of the blue structural color film obtained in Embodiment 2.

FIG. 6 is a plane scanning electron microscopy image of the red structural color film obtained in Embodiment 3.

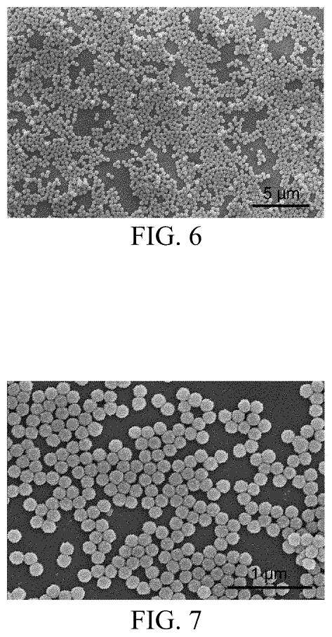

FIG. 7 is a plane scanning electron microscopy image of the purple structural color film obtained in Embodiment 4.

### DETAILED DESCRIPTION OF PREFERRED EMBODIMENTS

The following non-limiting embodiments can enable those skilled in the art to understand the present disclosure more comprehensively, but do not limit the present disclosure in any way.

The test methods in the following embodiments are conventional methods unless otherwise specified. Unless otherwise specified, the reagents and materials can be obtained commercially or prepared by conventional methods.

### Embodiment 1

Preparation of ZnS Microspheres:

3.00 g of polyvinylpyrrolidone (PVP) was fully dissolved in 100 ml of deionized water to obtain a uniform solution. The uniform solution was heated to 75° C. with stirring. 3.75 g of thioacetamide was added into the reaction system; 0.07 ml of concentrated nitric acid was added into the reaction system. 8.92 g of zinc nitrate hexahydrate was pre-dissolved in 5 ml of deionized water, then quickly added to the reaction system and stirred at 1000 rpm for 3 minutes. The stirring speed was turned down to 500 rpm and the reaction system was reacted at 75° C. for 3 hours with stirring. After centrifugation, the product was washed with water for 3 times, dried and ground to obtain ZnS microspheres with a particle size of 320 nm.

A structural color coating based on Mie scattering of high-refractive index microsphere, includes the components in parts by mass as follows: 5 parts of ZnS microspheres with a particle size of 320 nm, 90 parts of deionized water, 1 part of sodium dodecyl benzene sulfonate, and 4 parts of polyvinyl alcohol.

The above components in parts by mass were weighed respectively and mixed in a beaker; the stirring speed was adjusted to 700 rpm to magnetically stir for 30 minutes, and ultrasonic dispersed for 60 minutes, thereby each component was fully and evenly dispersed in deionized water to obtain the structural color coating.

The said structural color coating was sprayed by a spray gun, and the selected substrate was a silicon wafer. By spraying coating, the microspheres were assembled into a single-layer local microcosmic ordered and macroscopic long-range disordered structure on the matrix, thereby built a uniform green structural color film on the surface of the silicon wafer.

The obtained structural color film was characterized by a scanning electron microscopy, as shown in FIG. 1 of the plane scanning electron microscopy and the FIG. 2 of cross-sectional scanning electron microscopy. After being sprayed on the surface of the silicon wafer, the structural color coating built a single-layer local microscopic ordered and macroscopic long-range disordered structure.

As can be seen from the reflection spectrum of FIG. 3 and the scattering spectrum of FIG. 4, the obtained structure color film has an obvious reflection peak at 520 nm, that is, it can display a brilliant green structure color.

### Embodiment 2

By changing the amount of the zinc nitrate hexahydrate in the preparation of ZnS microspheres in Embodiment 1 to 5.95 g, ZnS microspheres with a particle size of 280 nm was prepared.

A blue structural color coating based on Mie scattering of high-refractive index microsphere, includes the components in parts by mass as follows: 10 parts of ZnS microspheres with a particle size of 280 nm, 85 parts of deionized water, 2 parts of sodium dodecyl benzene sulfonate and 3 parts of polyvinyl alcohol.

The above components in parts by mass were weighed respectively and mixed in a beaker; the stirring speed was adjusted to 700 rpm to magnetically stir for 30 minutes, and ultrasonic dispersed for 60 minutes, thereby each component was fully and evenly dispersed in deionized water to obtain the structural color coating.

The said structural color coating was sprayed by a spray gun, and the selected substrate was a metal plate. By spraying coating, the microspheres were assembled into a single-layer local microcosmic ordered and macroscopic long-range disordered structure on the metal plate, thereby built a uniform blue structural color film on the surface of the metal plate. The plane structure is shown in the scanning electron microscopy of FIG. 5.

### Embodiment 3

Preparation of CdS Microspheres:

6.00 g of PVP was dissolved in 150 ml of diethylene glycol solution, and 7.71 g of chromium nitrate tetrahydrate and 1.90 g of thiourea were added in the solution, and the solution was stirred until all the powder was completely dissolved. The solution was heated to 150 to 160° C. to heat react for 5 h, and then was cooled to room temperature. After centrifugation, the product was washed with ethanol and water for 3 times, dried and ground to obtain CdS microspheres with a particle size of 390 nm.

A structural color coating based on Mie scattering of high-refractive index microsphere, includes the components in parts by mass as follows: 1 part of CdS microspheres with a particle size of 390 nm, 90 parts of ethanol, 4 parts of cetyl sodium sulfate and 5 parts of sodium silicate.

The above components in parts by mass were weighed respectively and mixed in a beaker; the stirring speed was adjusted to 700 rpm to magnetically stir for 30 minutes, and ultrasonic dispersed for 60 minutes, thereby each component was fully and evenly dispersed in ethanol to obtain the structural color coating.

The said structural color coating was sprayed on the selected substrate of a stainless steel sheet. By spraying coating, the microspheres were assembled into a multi-layer local microcosmic ordered and macroscopic long-range disordered structure on the matrix, and thereby built a uniform red structural color film on the surface of the stainless steel sheet. The plane structure is shown in the scanning electron microscopy of FIG. 6.

### Embodiment 4

Preparation of Cu₂O Microspheres:

2.416 g of copper nitrate powder was added to 200 ml of diethylene glycol, and the solution was stirred until the powder was completely dissolved, to obtain the copper source precursor solution. 1 g of PVP powder was added to 30 mL of diethylene glycol, after the solution was stirred until the powder was completely dissolved, a certain amount of copper nitrate solution was added in it to make the concentration of Cu′ to be 5-20 mM. The solution was heated to 150 to 170° C. under the protection of N₂ to heat react for 1 h, and then was cooled to room temperature. After centrifugation, the product was washed for 3 times and dried to obtain Cu₂O microspheres with a particle size of 200 nm.

A structural color coating based on Mie scattering of high-refractive index microsphere, includes the components in parts by mass as follows: 20 parts of Cu₂O microspheres with a particle size of 200 nm, 75 parts of ethanol, 5 parts of stearic acid and 1 part of polyethyl acrylate.

The above components in parts by mass were weighed respectively and mixed in a beaker; the stirring speed was adjusted to 700 rpm to magnetically stir for 30 minutes, and ultrasonic dispersed for 60 minutes, thereby each component was fully and evenly dispersed in ethanol to obtain the structural color coating.

The said structural color coating was bladed on the selected substrate of a plastic sheet. By blade coating, the microspheres were assembled into a multi-layer local microcosmic ordered and macroscopic long-range disordered structure on the matrix, and thereby built a uniform purple structural color film on the surface of the plastic sheet. The plane structure is shown in the scanning electron microscopy of FIG. 6.

### Embodiments 5 to 8

By changing the amount of the zinc nitrate hexahydrate in the preparation of ZnS microspheres in Embodiment 1 to 5.20 g, 6.63 g, 10.69 g and 11.88 g respectively, correspondingly ZnS microspheres with particle sizes of 270 nm, 290 nm, 350 nm and 370 nm were respectively prepared.

The particle sizes of ZnS microspheres used in Embodiment 1 was replaced by 270 nm, 290 nm, 350 nm and 370 nm respectively, and the structural color coatings of blue, cyan, yellow and orange were respectively obtained.

### Embodiments 9 to 15

Preparation of ZnO Microspheres:

1.00 g of PVP and 200 ml of ethanol were mixed to obtain a uniform solution, and the solution was heated to 80° C. with stirring. 4.399 g of zinc acetate dihydrate was pre-dissolved in 3 mL of deionized water and then was quickly added to the reaction system to react for 2 hours under 80° C. with stirring. After centrifugation, the product was washed for 3 times and dried to obtain ZnO microspheres with a particle size of 300 nm.

Preparation of CaS Microspheres:

3.00 g of PVP was fully dissolved in 100 mL of deionized water to obtain a uniform solution, and the solution was heated to 75° C. with stirring. 2.25 g of thioacetamide was added in the reaction system, and 0.07 mL of concentrated nitric acid was added in the reaction system. 3.33 g of calcium chloride was pre-dissolved into 5 mL of deionized water and then was quickly added to the reaction system and stirred at 1000 rpm for 3 minutes. The stirring speed was turned down to 500 rpm, and the solution was reacted at 75° C. for 3 hours with stirring. After centrifugation, the product was washed for 3 times and dried to obtain CaS microspheres with a particle size of 310 nm.

Preparation of CuS Microspheres:

3.00 g of PVP was fully dissolved in 100 mL of deionized water to obtain a uniform solution, and the solution was heated to 75° C. with stirring. 2.25 g of thiourea was added in the reaction system, and 0.07 mL of concentrated nitric acid was added in the reaction system. 7.25 g of copper nitrate trihydrate was pre-dissolved in 5 mL of deionized water and then was quickly added to the reaction system and stirred at 1000 rpm for 3 minutes. The stirring speed was turned down to 500 rpm, and the solution was reacted at 75° C. for 2 hours with stirring. After centrifugation, the product was washed for 3 times and dried to obtain CuS microspheres with a particle size of 310 nm.

Preparation of Cu₂S Microspheres:

100 mL of ethanol, 2.25 g of thiourea and 5.10 g of copper chloride dihydrate were uniformly mixed with stirring, and then the solution was added in to a reaction kettle which was placed in the heating furnace. The temperature inside the furnace was set at 160° C. to react for 7 hours. After centrifugation, the product was washed for 3 times and dried to obtain Cu₂S microspheres with a particle size of 310 nm.

Preparation of TiO₂ Microspheres:

N-butyl titanate was added to anhydrous ethanol to prepare a mixed solution with a concentration of 0.02 M, and mercaptoacetic acid was added to the mixed solution with a concentration of 6×10⁻³ m, and then the solution was stirred for 10 hours at 22° C. Deionized water was added to the above mixed solution with vigorous stirring, wherein the dosage ratio of titanium precursor, anhydrous alcohol solvent, organic ligand and deionized water was 0.001 mol:0.8 mol:2.9×10⁻⁴ mol:0.27 mol. The precipitation was separated by centrifugation, and the product was dried at 80° C. to obtain uniform TiO₂ microspheres with a particle size of 310 nm.

Preparation of ZrO₂ Microspheres:

80 mL of cyclohexane, 10 mL of triton and 10 mL of hexyl alcohol were mixed to obtain an oil phase system. 3.22 g of Zirconium oxychloride and 3.83 g of yttrium nitrate were weighed to prepare an aqueous phase system with the same volume as the oil phase. The aqueous phase system was added to the oil phase system, and the mixture was transferred to a three-mouth flask and stirred at 75° C. for 4 hours. After centrifugation, the product was washed for 3 times and dried to obtain ZrO₂ microspheres with a particle size of 310 nm.

Preparation of CeO₂ Microspheres:

5.48 g of ceric ammonium nitrate, 5.88 g of sodium citrate and 50 mL of deionized water were mixed and stirred evenly. 6.01 g of carbamide was dissolved in 10 mL of deionized water, and then the carbamide solution was dropwise added into the mixed solution, and the mixed solution was transferred to the reaction kettle after stirred for 60 minutes. The reaction kettle was placed in the heating furnace, and the temperature inside the furnace was set at 200° C. to react for 24 hours. After centrifugation, the product was washed for 3 times and dried to obtain CeO₂ microspheres with a particle size of 310 nm.

The high-refractive index microspheres used in Embodiment 1 was replaced by ZnO, CaS, CuS, Cu₂S, TiO₂, ZrO₂ and CeO₂ microspheres with a particle size of 310 nm respectively, and the structural color coatings of blue, yellow, orange-yellow, yellow-green orange, cyan and turquoise were obtained respectively.

### Embodiments 16 to 17

The structural color coating in Embodiment 1 was roll coated and dip-coated on the selected substrate of glass. By roll coating and dip-coating, the microspheres were assembled into a multi-layer local microscopic ordered and macroscopic long-range disordered structure on the glass matrix, building a uniform green structural color film on the glass surface.

### Embodiments 18 to 19

The structural color coating in Embodiment 1 was sprayed on the selected substrates of ceramic, silk, and leather respectively. By spraying coating, the microspheres were assembled into a single-layer local microscopic order and macroscopic long-range disordered structure on the matrix, building a uniform green structural color film on the surfaces of ceramic, silk and leather respectively.

1. A structural color coating based on Mie scattering of high-refractive index microsphere, comprising components in parts by mass as follows: 5 to 20 parts of nano microspheres having a highly uniform particle size and a theoretical refractive index greater than 1.7, 75 to 90 parts of dispersion liquid, 0.1 to 5 parts of surfactant, and 1 to 5 parts of adhesive; the structural color coating building a local microcosmic ordered and macroscopic long-range disordered structural film on a matrix by means of spraying coating, blade coating, brushing coating, roll coating or dip-coating;
wherein the matrix is glass, metal, textile, ceramic, plastic or paper; the surfactant is sodium dodecyl benzene sulfonate, cetyl sodium sulfate, stearic acid and sodium stearate;
wherein the nano microsphere having a highly uniform particle size and a theoretical refractive index greater than 1.7 is at least one of ZnS, ZnO, CdS, Cu₂O, CaS, CuS, Cu₂S, TiO₂, ZrO₂ and CeO₂; and
wherein a particle size of the high-refractive index microsphere ranges from 200 to 500 nm.

2. The structural color coating based on Mie scattering of high-refractive index microsphere according to claim 1, wherein the dispersion liquid is a hydrophilic solution having a low boiling point.

3. The structural color coating based on Mie scattering of high-refractive index microsphere according to claim 1, wherein the dispersion liquid is at least one of acetone, water and ethanol.

4. The structural color coating based on Mie scattering of high-refractive index microsphere according to claim 1, wherein the adhesive is at least one of polyvinyl alcohol, polymethyl acrylate, polyethyl acrylate, polybutyl acrylate, polymethyl methacrylate, polyethyl methacrylate, polybutyl methacrylate and sodium silicate.
